(19) United States
(12) Patent Application Publication
(10) Pub. No.: US 2017/0353753 A1
(43) Pub. Date: Dec. 7, 2017

(54) COMMUNICATION APPARATUS, COMMUNICATION CONTROL METHOD, AND COMMUNICATION SYSTEM

(71) Applicant: CANON KABUSHIKI KAISHA, Tokyo (JP)

(72) Inventor: Takeshi Ozawa, Kawasaki-shi (JP)

(21) Appl. No.: 15/610,353

(22) Filed: May 31, 2017

(30) Foreign Application Priority Data
Jun. 3, 2016 (JP) 2016-111626

(51) Int. Cl. H04N 21/262; H04N 21/84; H04N 21/81; H04N 21/643; H04N 21/4223; H04N 5/247; H04N 21/239; H04N 21/235; H04N 5/44; H04N 5/38; H04N 21/858; H04N 21/458

(52) U.S. Cl. CPC H04N 21/26258; H04N 21/8586; H04N 21/84; H04N 21/816; H04N 21/64322; H04N 21/458; H04N 5/247; H04N 21/2393; H04N 21/2353; H04N 5/44; H04N 5/38; H04N 21/4223

(57) ABSTRACT

A communication apparatus includes an acquisition unit configured to acquire image capture information associated with a plurality of image capturing apparatuses, a generation unit configured to generate a playlist in which access information associated with a plurality of pieces of video data captured by the plurality of image capturing apparatuses and the image capture information acquired by the acquisition unit are described, and a transmission unit configured to transmit the playlist generated by the generation unit to another communication apparatus.

### BACKGROUND OF THE INVENTION

### Field of the Invention

The present disclosure relates to a communication apparatus, a communication control method, and a communication system.

### Description of the Related Art

In recent years, use of virtual viewpoint video technology (free viewpoint video technology) has become increasingly popular. A virtual viewpoint video image is a video image of an object of interest seen from a virtual viewpoint. The virtual viewpoint video image is obtained based on video images captured by a plurality of cameras disposed around the object. By distributing, via a network, video data acquired by a plurality of cameras, it is possible to allow a plurality of network-connected viewers to view the object from their own free viewpoints.

Japanese Patent Laid-Open No. 2013-183209 discloses a system in which it is allowed to view a multi-viewpoint video content from a free viewpoint. In the system disclosed in Japanese Patent Laid-Open No. 2013-183209, a streaming server distributes a streaming content of a multi-viewpoint video image. A client PC displays a video image corresponding to a viewpoint selected by a viewer based on the distributed streaming content of the multi-viewpoint video image.

The conventional system described above is a system in which it is assumed that viewers know an image capture configuration including an arrangement of cameras or the like. However, for example, in a case where unspecified many network-connected viewers view virtual viewpoint video images using their own various types of client devices, the viewers do not necessarily know the image capture configuration. Therefore, in the conventional system described above, there is a possibility that it is not possible for a viewer to properly select a video image.

### SUMMARY OF THE INVENTION

The present disclosure provides a communication apparatus including an acquisition unit configured to acquire image capture information associated with a plurality of image capturing apparatuses, a generation unit configured to generate a playlist in which access information associated with a plurality of pieces of video data captured by the plurality of image capturing apparatuses and the image capture information acquired by the acquisition unit are described, and a transmission unit configured to transmit the playlist generated by the generation unit to another communication apparatus.

Further features of the present invention will become apparent from the following description of exemplary embodiments with reference to the attached drawings.

### BRIEF DESCRIPTION OF THE DRAWINGS

FIG. 1 is a schematic diagram illustrating an example of a communication system.

FIG. 2 is a block diagram illustrating a functional configuration of a camera.

FIG. 3 is a block diagram illustrating a functional configuration of a server apparatus.

FIG. 4 is a flow chart illustrating an operation of a server apparatus.

FIG. 5A is a diagram illustrating an example of a structure of an MPD.

FIG. 5B is a diagram illustrating an example of an MPD.

FIG. 6 is a flow chart illustrating an operation of a client apparatus.

FIG. 7 is a diagram illustrating another example of an MPD.

FIG. 8 illustrates an example of a hardware configuration of a communication apparatus.

### DESCRIPTION OF THE EMBODIMENTS

Embodiments of the present disclosure are described in detail below with reference to accompanying drawings.

Note that embodiments described below are merely examples of implementations of the present disclosure, and modifications and changes are possible depending on a configuration of an apparatus according to the present disclosure and depending on various conditions, and thus the present disclosure is not limited to the embodiments described below.

In a communication system according to an embodiment, it is possible to perform bidirectional communication among a plurality of communication apparatuses. In the present embodiment, as for a communication protocol, MPEG-DASH (Dynamic Adaptive Streaming over Http) is used which is a communication protocol for transmitting a stream of video data via a network such as the Internet. Hereinafter, for the sake of simplicity, MPEG-DASH will be referred to as DASH. The present embodiment is described mainly with reference to an example in which the communication system treats a moving image. However, the communication system may also treat a still image. That is, in the present embodiment, video data may be either moving image data or still image data.

DASH has a feature that makes it possible to dynamically select and transmit suitable video data depending on processing power of a receiving terminal or a communication state. More specifically, the feature of the DASH allows it to switch the bit rate depending on the band. For example, in a case where a network is congested and thus an available bandwidth is narrow, the bit rate is changed such that no interruption occurs in reproduction.

A DASH distribution server prepares segment video images obtained by dividing video data into segments with arbitrary capture time intervals. Each segment video image is a segment of video data (a segment) with a length of several seconds capable of being individually reproduced. To perform switching of the bit rate described above, the distribution server may prepare in advance segments corresponding to a plurality of bit rates. The distribution server may further prepare in advance segments corresponding to a plurality of resolutions.

A DASH management server generates a MPD (Media Presentation Description) which is a playlist of video data. The MPD is a list of acquired video data. The MPD includes information representing video data, such as access information (URL: Uniform Resource Locator) associated with each segment prepared by the distribution server, feature information of each segment, and the like. The feature information includes information about a type (compression method) of a segment, a bit rate, a resolution, and the like. The DASH distribution server and the management server may be realized by the same single server or may be realized separately.

A DASH play client first acquires an MPD from the distribution server, and analyzes the acquired MPD. As a result, the play client acquires access information and feature information of each segment described in the MPD. Next, depending on a communication state or a user command, the play client selects a segment to be played from the segment list described in the MPD. The play client then acquires a segment from the distribution server based on the access information of the selected segment, and plays a video image.

Thus, in the communication system of the type described above, it is important to, on a server side, describe feature information of each segment properly in the MPD such that it becomes possible to, on a client side, to properly select a segment. On the client side, it is important to properly select a segment that serves a purpose based on the feature information described in the MPD.

In the communication system according to the present embodiment, the communication apparatus on the server side describes image capture information as supplementary information in the MPD. The image capture information includes information regarding a physical (spatial) arrangement (positions) of cameras by which video images are captured, information regarding angles of view, and information indicating a relationship (positional relationship) in terms of physical positions between the cameras and an object being captured. The communication apparatus on the client side receives the MPD transmitted from the communication apparatus on the server side, and analyzes the received MPD. The communication apparatus on the client side then selects a segment based on the information including the image capture information described in the MPD.

Note that, a following description of the present embodiment is given for a case where MPEG-DASH is used as a communication protocol. However, the communication protocol is not limited to MPEG-DASH. As for the communication protocol, alternatively, HLS (Http Live Streaming) or other similar communication protocols may be used. The format of the playlist is not limited to the MPD format defined by MPEG-DASH, but a playlist format defined by HLS or other similar playlist formats may be used.

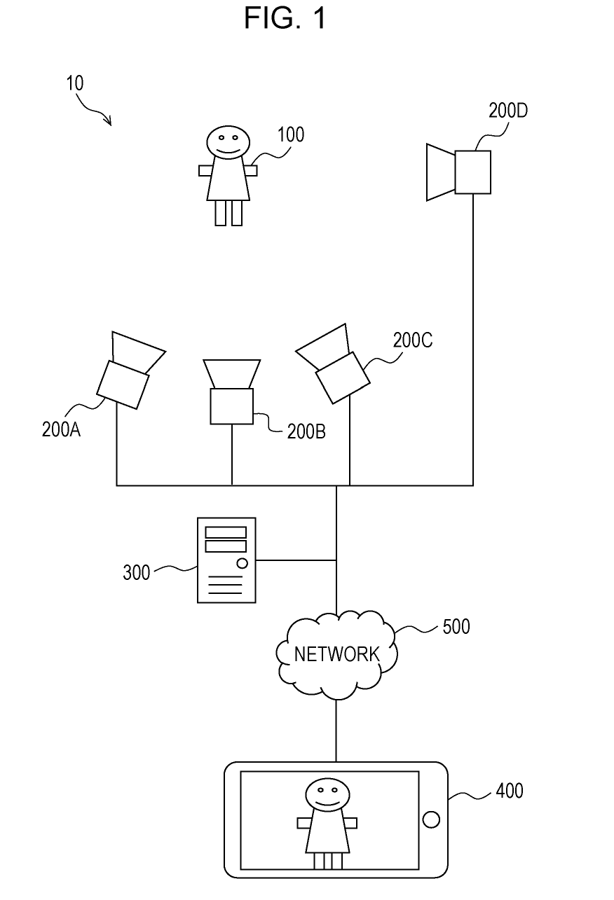

FIG. 1 is a schematic diagram illustrating an example of a communication system 10 according to the present embodiment. In the present embodiment, the communication system 10 is applied to a system in which video data captured by a plurality of image capturing apparatuses disposed at different locations is distributed via a network, and a virtual viewpoint video image is viewed at one or more network-connected client apparatuses.

The communication system 10 includes a plurality of cameras 200A to 200D (four cameras in the example shown in FIG. 1) that capture images of an object 100 to be captured, a server apparatus 300, and a client apparatus 400. The cameras 200A to 200D, the server apparatus 300 and the client apparatus 400 are connected to each other via a network 500 such that they are allowed to communicate with each other. In the present embodiment, the virtual viewpoint video image is a video image virtually representing an image that would be obtained by capturing an image of an object from a virtual viewpoint specified by the client apparatus 400. There may a certain restriction on a range within which the client apparatus 400 is allowed to specify the viewpoint, or the allowable viewpoint range may vary depending on the type of the client apparatus 400.

The object 100 is a target object to be captured as the virtual viewpoint video image. In the example shown in FIG. 1, the object 100 is a person. However, the object 100 may be an object other than a person.

The cameras 200A to 200D are image capturing apparatuses that capture images of the object 100. Specific examples of the cameras 200A to 200D include a video camera, a smartphone, a tablet terminal, and the like. However, the cameras 200A to 200D are not limited to these devices described above, as long as a functional configuration described later is satisfied. Furthermore, the communication system 10 may include a plurality of cameras serving as image capturing apparatuses, and there is no particular restriction on the number of cameras.

The cameras 200A to 200D each have a function of compression-encoding the captured image and generating video data (a segment) in a DASH segment format. The cameras 200A to 200D each also have a function of, in a case where a segment transmission request is received from the client apparatus 400, transmitting segment data to the client apparatus 400 via a network. That is, the cameras 200A to 200D function as the distribution server described above. A storage apparatus may be provided to store segments generated by the cameras 200A to 200D, and the distribution server may be realized by this storage apparatus.

The server apparatus 300 is a server-side communication apparatus having a function of generating an MPD associated with segments generated by the cameras 200A to 200D and a function of distributing the MPD to the client apparatus 400 via a network. The server apparatus 300 may be realized using a personal computer (PC). In the present embodiment, the server apparatus 300 receives segment information (access information, feature information) associated with segments and the image capture information described above from the cameras 200A to 200D, and generate an MPD. A method of generating the MPD will be described in detail later.

This server apparatus 300 functions as the management server described above. Note that one of the plurality of cameras 200A to 200D may be configured so as to function as a communication apparatus to realize functions of respective units of the server apparatus 300.

The client apparatus 400 is a terminal apparatus operable by a viewer of a virtual viewpoint video image. The client apparatus 400 is a client-side communication apparatus having a function of receiving and analyzing the MPD transmitted from the server apparatus 300 and a function of selecting at least one segment based on a result of the analysis and requesting a corresponding camera to transmit the segment.

The client apparatus 400 selects a segment, depending on a communication state or a user command, from a segment list obtained via the analysis of the MPD. More specifically, the client apparatus 400 selects a segment having a proper bit rate or a resolution depending on a status of a network band, a CPU utilization rate, and a screen size of a monitor on which the video image is displayed.

Furthermore, in accordance with a command issued by a viewer to specify a viewpoint of a virtual viewpoint video image and based on image capture information included in the MPD, the client apparatus 400 selects at least one segment desired by the viewer. The client apparatus 400 then detects the access information (URL) of the segment described in the MPD and requests a corresponding camera to transmits the selected segment.

The client apparatus 400 further has a function of receiving the segment transmitted, in response to the segment transmission request, from the camera and displaying the received segment. More specifically, the client apparatus 400 decodes the received segment and displays the decoded segment on the display unit.

This client apparatus 400 functions as the play client described above. Specific examples of the client apparatus 400 include a smartphone, a tablet terminal, a PC, and the like. However, the client apparatus 400 is not limited to these devices as long as a functional configuration described later is satisfied. Note that the communication system 10 may include a plurality of client apparatuses. However, in the present embodiment, for the sake of simplicity, the communication system 10 includes only one client apparatus.

The network 500 may be realized by a LAN (Local Area Network), or a WAN (Wide Area Network) such as the Internet, LTE (Long Term Evolution), 3G, or the like, or a combination of two or more of these networks. The connection to the network 500 may be wired or wireless.

Note that in the present embodiment, there is no restriction on a method of measuring physical locations of the cameras 200A to 200D, and any measurement method may be used. Furthermore, in the present embodiment, any method may be used by the server apparatus 300 to find the cameras 200A to 200D on the network 500, and any method may be used by the client apparatus 400 to acquire the address of the server apparatus 300.

Next, a specific configuration of each of the cameras 200A to 200D is described below. The cameras 200A to 200D are identical in configuration, and thus, by way of example, the configuration of the camera 200A is explained below.

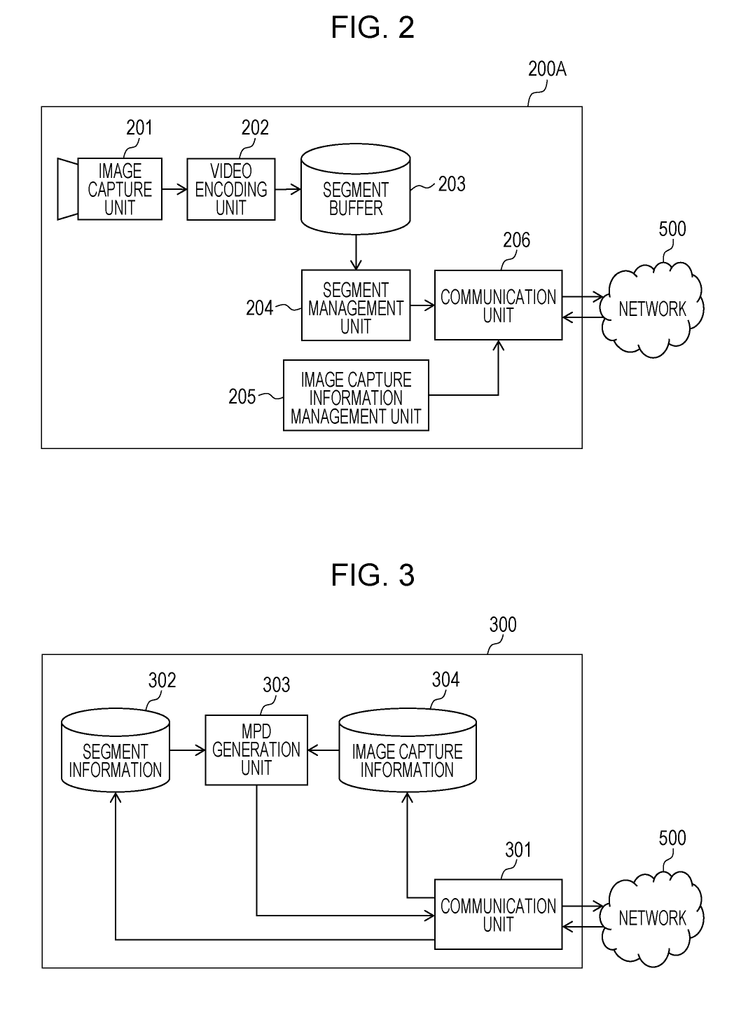

FIG. 2 is a block diagram illustrating a functional configuration of the camera 200A. The camera 200A includes an image capture unit 201, a video encoding unit 202, a segment buffer 203, a segment management unit 204, an image capture information management unit 205, and a communication unit 206. The image capture unit 201 captures an image of the object 100, and outputs resultant video data. In this process, the image capture unit 201 outputs the captured video data in units of frames to the video encoding unit 202.

The video encoding unit 202 compression-encodes the video data output from the image capture unit 201 into an H.264 format or the like. Furthermore, the video encoding unit 202 segments the compression-encoded video data into segments in a media format supported by DASH. The media format supported by DASH may be the ISOBMFF (Base Media File Format) such as the MP4 format, the MPEG-2TS (MPEG-2 Transport Stream) format, or the like. The video encoding unit 202 stores the segmented video data (segments) in the segment buffer 203.

The segment buffer 203 is configured to write and read segments.

When a segment from the video encoding unit 202 is stored in the segment buffer 203, the segment management unit 204 generates information (segment information) regarding this segment. The segment management unit 204 then transmits the generated segment information to the server apparatus 300 via the communication unit 206 and the network 500. The timing of transmitting the segment information to the server apparatus 300 may be the same as or different from the timing of receiving a transmission request for the segment information from the server apparatus 300.

When the segment management unit 204 is requested by the client apparatus 400 to transmit the segment stored in the segment buffer 203, the segment management unit 204 transmits the requested segment to the client apparatus 400 via the communication unit 206 and the network 500.

The image capture information management unit 205 stores image capture information including information regarding the position of camera 200A, information regarding the angle of view, and information regarding the positional relationship between the camera 200A and the target object. The image capture information management unit 205 transmits, as necessary, the image capture information to the server apparatus 300 via the communication unit 206 and the network 500. The image capture information management unit 205 may transmit the image capture information at regular intervals or may transmit new image capture information when a change occurs in image capture information.

The communication unit 206 is a communication interface for communicating with the server apparatus 300 or the client apparatus 400 via the network 500. The communication unit 206 realizes communication control in transmission of segment information and image capture information to the server apparatus 300, reception of a segment transmission request transmitted from the client apparatus 400, and transmission of a segment to the client apparatus 400.

Next, a specific configuration of the server apparatus 300 is described below.

FIG. 3 is a block diagram illustrating a functional configuration of the server apparatus 300. The server apparatus 300 includes a communication unit 301, a segment information storage unit 302, an MPD generation unit 303, and an image capture information storage unit 304. The communication unit 301 is a communication interface for communicating with the cameras 200A to 200D or the client apparatus 400 via the network 500. The communication unit 301 realizes communication control in reception of segment information and image capture information transmitted from the cameras 200A to 200D, reception of an MPD transmission request transmitted from a client apparatus 400 described later, and transmission of an MPD to the client apparatus.

When the communication unit 301 receives segment information transmitted from the cameras 200A to 200D, the communication unit 301 stores the received segment information in the segment information storage unit 302. Similarly, when the communication unit 301 receives image capture information transmitted from the cameras 200A to 200D, the communication unit 301 stores the received image capture information in the image capture information storage unit 304. The segment information storage unit 302 is configured to write and read segment information, and the image capture information storage unit 304 is configured to write and read image capture information.

When the communication unit 301 receives an MPD transmission request from the client apparatus 400, the MPD generation unit 303 acquires segment information, from the segment information storage unit 302, regarding a segment to be described in the MPD. The MPD generation unit 303 further acquires image capture information regarding the segment to be described in the MPD from the image capture information storage unit 304. The MPD generation unit 303 then generates the MPD based on the acquired information, and transmits, via the network, the generated MPD to the client apparatus 400 from which the MPD transmission request is received. In the present embodiment, the MPD generation unit 303 generates the MPD in which the segment information is described, and describes the image capture information in this MPD.

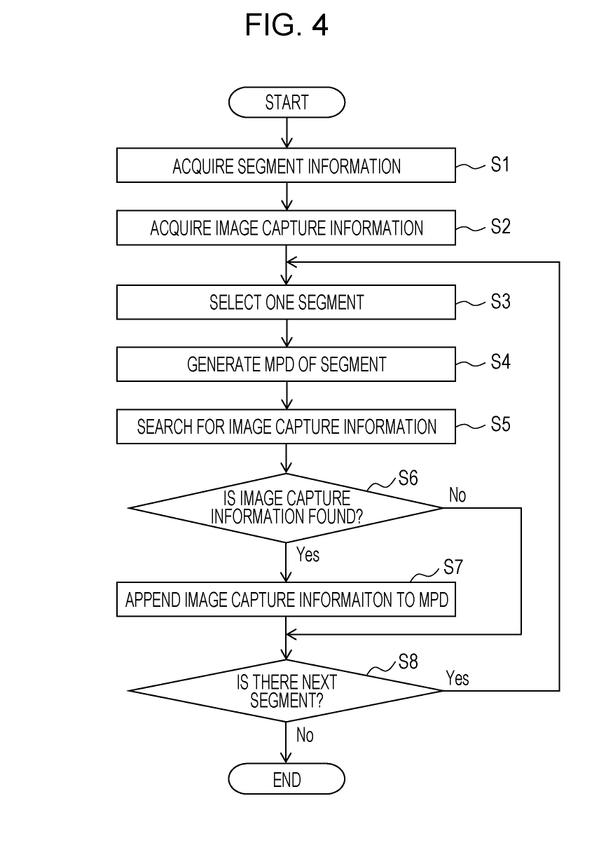

The procedure of generating the MPD by the MPD generation unit 303 is described below with reference to FIG. 4. Note that in the following description, an alphabet S denotes a step in a flow chart.

First, in S1, the MPD generation unit 303 acquires segment information set from the segment information storage unit 302. The segment information set includes segment information regarding a plurality of segments generated by a plurality of cameras 200A to 200D. Next, in S2, the MPD generation unit 303 acquires image capture information associated with the plurality of cameras 200A to 200D from the image capture information storage unit 304. In S3, the MPD generation unit 303 selects one segment from a segment set corresponding to the segment information set acquired in S1. Thereafter, the processing flow proceeds to S4, in which the MPD generation unit 303 generates an MPD regarding the segment selected in S3.

Next, a structure of the MPD is described below.

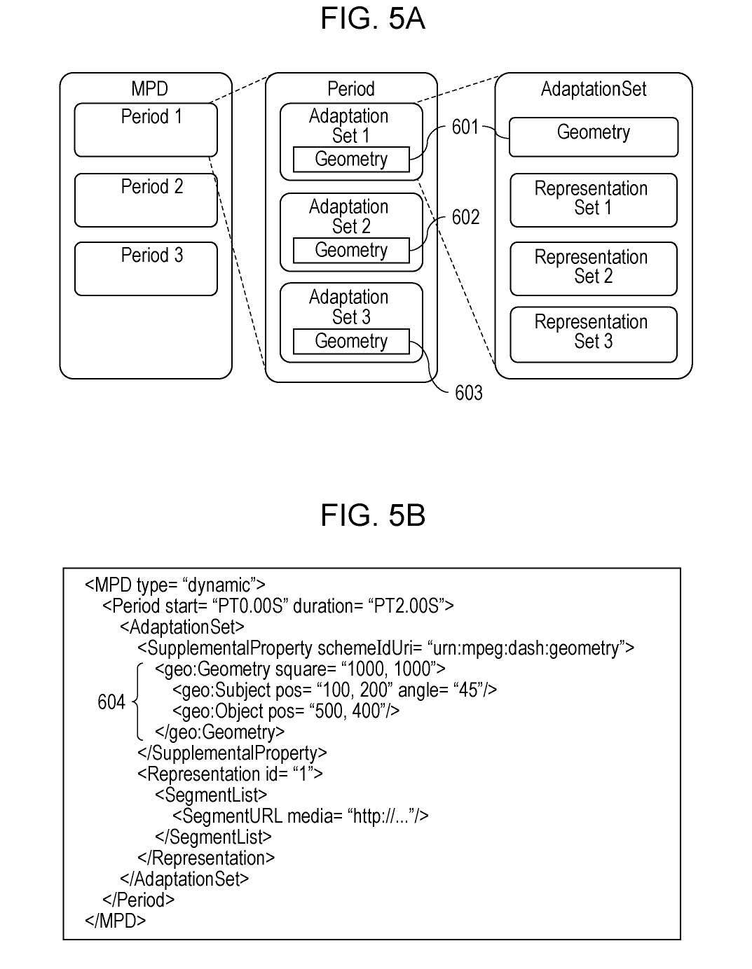

The MPD is described in a hierarchical structure using a markup language such as XML. More specifically, as shown in FIG. 5A, the MPD may be described in a hierarchical structure including a plurality of structures such as Period, AdaptationSet, and Representation. Period is a constituent unit of a content such as a program content. As shown in FIG. 5A, the MPD includes one or more Periods. In each Period, as shown in FIG. 5B, a start time and a duration time are defined. One period includes one or more AdaptationSets. AdaptationSet represents units in terms of a video image, a sound/voice, a subtitle, and/or the like of a content.

Representation may describe feature information in terms of a resolution or a bit rate of a video image, a bit rate of a voice/sound, and/or the like. Furthermore, as shown in FIG. 5B, Representation may describe access information (URL) of each segment using SegmentList. Note that AdaptationSet may include a plurality of Representations corresponding to different bit rates or resolutions.

In S4 in FIG. 4, based on the segment information regarding the segment selected in S3 in the segment information set acquired in S1, the MPD generation unit 303 generates an MPD in which access information and feature information are described.

In S5, the MPD generation unit 303 searches for image capture information associated with the segment selected in S3 from image capture information associated with the plurality of cameras 200A to 200D acquired in S2. In S6, the MPD generation unit 303 determines, based on a result of the search in S5, whether there is image capture information corresponding to the segment being searched for. In a case where the MPD generation unit 303 determines that image capture information is found, the MPD generation unit 303 advances the process to S7 in which the MPD generation unit 303 describes (appends) the image capture information regarding the segment of interest in the MPD generated in S4. The MPD generation unit 303 then advances the process to S8. On the other hand, in a case where the MPD generation unit 303 determines in S6 that there is no image capture information, the MPD generation unit 303 directly advances the process to S8.

A method of describing image capture information in an MPD is, as shown in FIG. 5A, to describe Geometry information 601 to 603 in an AdaptationSet in which information regarding image representation is described. In the MPD, a SupplementalProperty element, in which a new element may be defined, may be described in AdaptationSet. Thus, in the present embodiment, as denoted by a symbol 604 in FIG. 5B, image capture information is described by a tag surrounded by SupplementalProperty tags.

For example, a square property of a Geometry tag may be used to indicate a size of a plane area to explicitly indicate a position of a camera. Furthermore, a Subject tag in a Geometry tag may be used to indicate a position (pos) and an angle of view (angle) of a camera. Furthermore, an Object tag in a Geometry tag may be used to indicate a position (pos) of a target object of interest. Note that the position of the camera and the position of the object may be described using coordinates in the plane area.

As described above, the information regarding the position of the camera, the information regarding the angle of view, and the information regarding the positional relationship between the camera and the object may be described as properties of an AdaptationSet tag in the MPD. Thus, it is possible to properly transmit these pieces of image capture information to the client apparatus 400. Note that the above-described method of describing image capture information in the MPD is merely an example, and the format is not limited to the example shown in FIG. 5A or FIG. 5B. For example, in addition to the position of the object, a size of the object may be described. Furthermore, in addition to the information regarding the position and the angle of view of the camera, direction information indicating a capture direction of the camera may be described. As for the coordinate information regarding the position of the object, coordinate information indicating the center of the object may be used, or coordinate information indicating an upper left edge of an object area may be used. Furthermore, information regarding a plurality of objects may be described.

In S8 in FIG. 4, the MPD generation unit 303 determines whether the segment set corresponding to the segment information set acquired in S1 includes a segment for which an MPD is not yet generated. In a case where the MPD generation unit 303 determines that there is a segment for which an MPD is not yet generated, the MPD generation unit 303 returns the process to S3 to select a next segment and repeat the process from S4 to S7. On the other hand, in a case where the MPD generation unit 303 determines in S8 that an MPD has been generated for all segments, the MPD generation unit 303 ends the MPD generation process.

As described above, the server apparatus 300 is capable of describing image capture information regarding the plurality of cameras 200A to 200D in the MPD. That is, the server apparatus 300 is capable of describing, in the MPD, the positional relationship among the plurality of cameras 200A to 200D and the relationship in terms of the capture angle of view among the plurality of cameras 200A to 200D.

Thus, the client apparatus 400 is capable of detecting how the plurality of cameras 200A to 200D are positioned and which cameras are located adjacent to each other by analyzing the MPD transmitted from the server apparatus 300. Thus, the client apparatus 400 is capable of easily detecting the relationship among segments, for example, in terms of combinations of images captured by cameras located to adjacent to each other. That is, the image capture information described MPD is information indicating relationships among images. As a result, the client apparatus 400 is capable of properly selecting a segment that serves a purpose and transmitting a segment transmission request to a corresponding camera.

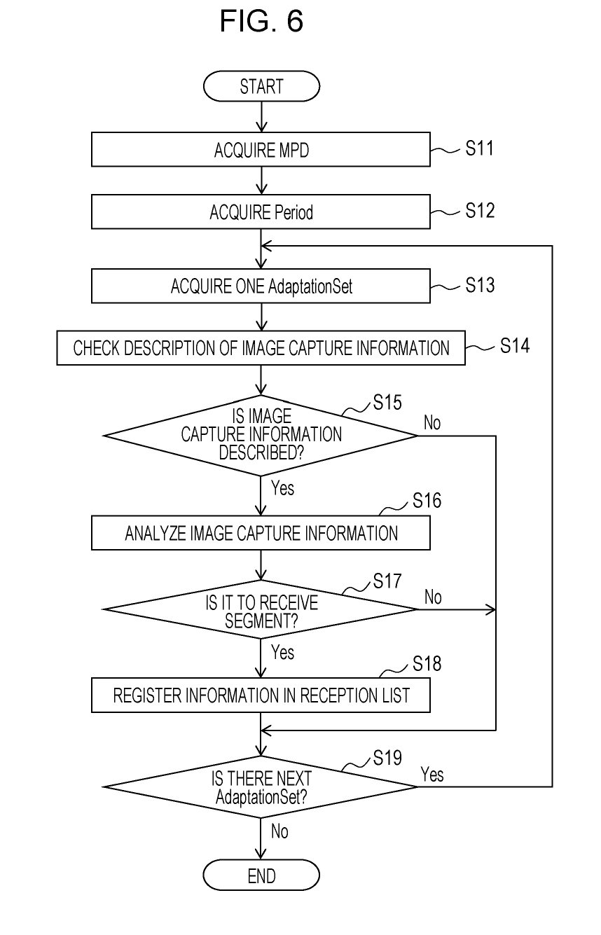

A procedure of a process, by the client apparatus 400, to select a segment satisfying a purpose based on a result of analysis of an MPD is described below with reference to a flow chart shown in FIG. 6.

First, in S11, the client apparatus 400 transmits a MPD transmission request to the server apparatus 300, and acquires an MPD transmitted in response to the request from the server apparatus 300. Next, in S12, the client apparatus 400 acquires, from the MPD acquired in S11, Period information describing a list of segments (SegmentList) that can be selected.

In S13, the client apparatus 400 selects one AdaptationSet element in the Period information acquired in S12. Next, in S14, the client apparatus 400 checks whether there is image capture information that can be described in AdaptationSet selected in S13. The client apparatus 400 then determines in S15 whether image capture information is described in AdaptationSet. In a case where the client apparatus 400 determines that image capture information is described as in the example shown in FIG. 5B, the client apparatus 400 advances the process to S16. In a case where the client apparatus 400 determines that image capture information is not described, the client apparatus 400 advances the process to S19.

In S16, the client apparatus 400 analyzes the image capture information described in AdaptationSet to detect the positions and the angles of view of the plurality of cameras and the positional relationship between the cameras and the object.

Next, in S17, the client apparatus 400 determines, based on a result of the analysis of the image capture information in S16, whether the segment is a segment that is to be received from the viewpoint of the image capture information of the camera. For example, in a case where the client apparatus 400 determines that the camera position corresponds to a viewpoint location specified by a viewer or in a case where the client apparatus 400 determines that the camera position nearly corresponds to the viewpoint location specified by the viewer, the client apparatus 400 determines that the segment is a segment that is to be received. When it is determined that the segment is a segment that is to be received, the client apparatus 400 advances the process to S18 in which the client apparatus 400 registers the information regarding this segment in a reception list. The client apparatus 400 then advances the process to S19.

In S19, the client apparatus 400 determines whether there is AdaptationSet that has not yet been subjected to the analysis. In a case where the client apparatus 400 determines that there is AdaptationSet that has not yet been subjected to the analysis, the client apparatus 400 returns the process to S13 to select a next AdaptationSet and repeat the process from S14 to S18. On the other hand, in a case where the client apparatus 400 determines that the analysis is completed for all AdaptationSets, the client apparatus 400 ends the process shown in FIG. 6.

Thereafter, the client apparatus 400 selects, from the segments registered in the reception list, at least one segment determined ultimately to be received from the point of view of the segment feature information, and the client apparatus 400 transmits a segment transmission request to a corresponding camera. Thus, the client apparatus 400 acquires a segment transmitted, in response to the segment transmission request, from the camera, and the client apparatus 400 controls displaying such that the segment is decoded and displayed on the display unit.

As described above, the server apparatus 300 serving as the communication apparatus according to the present embodiment acquires image capture information associated with the cameras 200A to 200D serving as a plurality of image capturing apparatuses that capture images of the object 100 which is an object of interest. Note that the image capture information includes at least one of the following: information regarding the physical arrangement of the image capturing apparatuses; information regarding the angles of view of the image capturing apparatuses; and information regarding the relationship in terms of physical positions between the image capturing apparatuses and the object. The server apparatus 300 describes image capture information in a playlist representing access information associated with a plurality of pieces of video data captured by the plurality of cameras 200A to 200D. Note that as for the format of the playlist, the MPD format defined in the MPEG-DASH may be employed. The server apparatus 300 then transmits the generated playlist to the client apparatus 400 serving as another communication apparatus.

Thus, the client apparatus 400 receives, from the server apparatus 300, the playlist in which the access information and the image capture information, and the client apparatus 400 are described, and the client apparatus 400 analyzes the received playlist. Thus, the client apparatus 400 is capable of detecting the physical arrangement and angles of view of the plurality of cameras 200A to 200D and the relationship in terms of the physical positions between the object 100 and the cameras 200A to 200D. Therefore, the client apparatus 400 is capable of selecting a segment that serves a purpose from a plurality of choices of segments based on the image capture information included in the playlist, and transmitting a request for the selected segment to a corresponding camera.

In recent years, research and implementation works in terms of various virtual viewpoint video images have been made for use at various usage locations and for various objects to be captured. In the case of a system in which video data captured by a plurality of cameras is distributed via a network, and network-connected viewers are allowed to view an object from virtual viewpoints, viewers may be unspecific and there may many such viewers, and client devices operated by viewers may be of many types. Thus, viewers do not necessarily know image capture conditions such as camera positions or the like, which may make it difficult for client devices to properly select reproduced images that serve purposes of the viewers.

In contrast, in the present embodiment, as described above, the server apparatus 300 generate the MPD describing the image capture information associated with the plurality of cameras 200A to 200D, and transmits the generated MPD to the client apparatus 400. Thus, the client apparatus 400 is capable of properly detecting the image capture conditions including the arrangement of cameras by analyzing the MPD in which the image capture information is described. Therefore, the client apparatus 400 is capable of properly selecting a reproduced image that serves a purpose of a viewer.

As described above, as for the method of transmitting the image capture information to the client apparatus 400, the server apparatus 300 employs a unified method in which image capture information is described in a playlist (MPD) used in distributing a stream of a content. Therefore, it is possible for various types of client devices at viewer sides to properly select an image even in a case in which a plurality of viewers connected to a network virtually switch camera images of various objects at various use locations.

When the server apparatus 300 describes the image capture information in the playlist, the server apparatus 300 may describe image capture information for each of segment video images at arbitrary capture time intervals of video image data. The server apparatus 300 may describe the image capture information such that the image capture information is included in information regarding the image representation included in the playlist.

More specifically, as shown in FIG. 5A, the server apparatus 300 may describe the image capture information in AdaptationSet. By describing the image capture information for each segment video image as described above, it is possible to represent a change with time in image capture information. By describing the image capture information such that the image capture information is included in information (AdaptationSet) regarding the image representation, it is possible to describe image capture information suitable depending on the image capture condition of the image representation.

Furthermore, as shown in FIG. 5B, the server apparatus 300 describes information regarding coordinates of cameras in a particular plane area and information regarding coordinates of an object in a particular plane area. Thus, it is possible to describe the information regarding the physical arrangement of cameras and the information regarding the relationship in physical positions between the cameras and the object such that these pieces of information are properly included in the playlist.

Note that the information regarding the physical arrangement of cameras and the information regarding the relationship in physical positions between the cameras and the object may be described in coordinates in a particular space region. In this case, instead of a square property in a Geometry tag, property information specifying the space region described may be described, and coordinates in the camera space region or the object space region may be described.

### Modifications

In the embodiments described above, as for the method of describing image capture information in the MPD, by way of example, image capture information is described in AdaptationSet using a SupplementalProperty element as shown in FIG. 5B. However, the method of describing image capture information in the MPD is not limited to that described above.

In the MPD, a SupplementalProperty element may be described in a Representation element in a similar manner to an AdaptationSet element. Thus, image capture information may be described in Representation using a SupplementalProperty element. That is, image capture information may be described as one display method using a Representation tag. Alternatively, image capture information may be described using another element such as an EssentialProperty element defined in the MPD in a similar manner to SupplementalProperty elements.

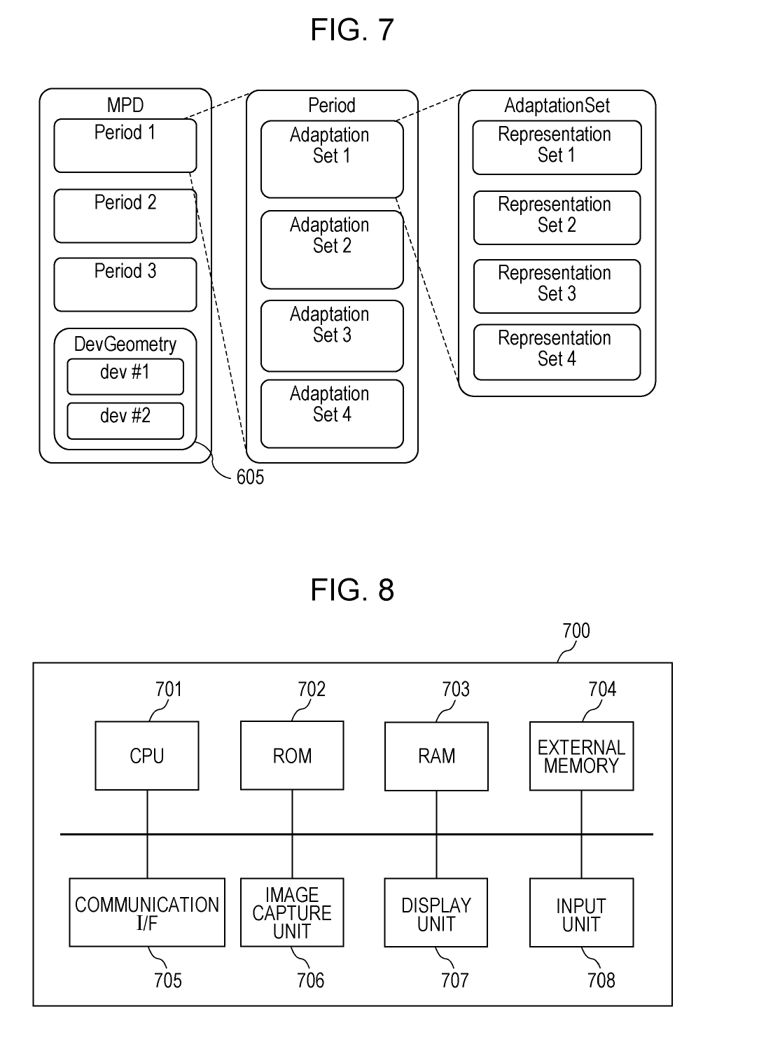

Furthermore, as shown in FIG. 7, image capture information may be described as DevGeometry information 605 independently of the description of Period elements. In this case, in the DevGeometry information 605, image capture information may be described for each camera using a camera ID (dev #1, #2, . . . ) or the like.

By describing image capture information independently of the description of information regarding segment video images, it is possible to describe image capture information in a static structure. Furthermore, because it is possible to describe image capture information using a common tag, it is easy to describe the image capture information in the MPD. In a case where image capture information is described u sing a common tag as described above, it may also be possible to image capture information for each segment using an ID of a Representation element for the sake of reference.

### Examples of Hardware Configurations

FIG. 8 illustrates an example of a hardware configuration of a computer 700 usable to realize a communication apparatus according to the present embodiment.

The computer 700 includes a CPU 701, a ROM 702, a RAM 703, an external memory 704, and a communication I/F 705. The CPU 701 is capable of realizing functions of the units of the embodiment described above by executing a program stored in the ROM 702, the RAM 703, the external memory 704, or the like. In the present embodiment, the communication apparatus is capable of realizing processes shown in FIG. 4 or processes shown in FIG. 6 by reading out and executing a necessary program by the CPU 701.

The communication I/F 705 is an interface configured to communicate with an external apparatus. The communication I/F 705 may function as the communication unit 206 shown in FIG. 2 or the communication unit 301 shown in FIG. 3.

The computer 700 may include an image capture unit 706, a display unit 707, and an input unit 708. The image capture unit 706 includes an image sensing device configured to capture an image of an object. The image capture unit 706 is capable of functioning as the image capture unit 201 shown in FIG. 2. In a case where the communication apparatus does not have a function of capturing an image, the image capture unit 706 is not necessary.

The display unit 707 may be realized using one of various types of displays. The display unit 707 may function as a display unit, which displays a video segment or the like, in the client apparatus 400. In a case where the communication apparatus does not have a display function, the display unit 707 is not necessary. The input unit 708 may be realized using a keyboard, a pointing device such as a mouse, a touch panel, or various types of switches. The input unit 708 is allowed to be operated by a viewer at the client apparatus 400. The viewer may input a position or the like of a viewpoint of a virtual viewpoint video image via the input unit 708. In a case where the communication apparatus does not have an input function, the input unit 707 is not necessary.

According to the present embodiment, in the communication apparatus configured to receive a video image based on video images captured by a plurality of image capturing apparatuses, it becomes possible to easily specify a video image to be received.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-111626, filed Jun. 3, 2016, which is hereby incorporated by reference herein in its entirety.

What is claimed is:

1. A communication apparatus comprising:
an acquisition unit configured to acquire image capture information associated with a plurality of image capturing apparatuses;
a generation unit configured to generate a playlist in which access information associated with a plurality of pieces of video data captured by the plurality of image capturing apparatuses and the image capture information acquired by the acquisition unit are described; and
a transmission unit configured to transmit the playlist generated by the generation unit to another communication apparatus.

2. The communication apparatus according to claim 1, wherein the image capture information includes at least one of the following: position information regarding spatial positions of the image capturing apparatuses; angle-of-view information regarding angles of view of the image capturing apparatuses; and relation information regarding a relationship in terms of physical positions between the image capturing apparatuses and a specific object.

3. The communication apparatus according to claim 1, wherein the generation unit generates a playlist in which the image capture information is described for each specific period.

4. The communication apparatus according to claim 1, wherein the generation unit describes the image capture information in a range according to a representation defined by MPEG-DASH.

5. The communication apparatus according to claim 1, wherein the generation unit generates a playlist in which the image capture information is described independently of division periods of the video image.

6. The communication apparatus according to claim 1, wherein the generation unit generates a playlist in which at least one of the information regarding the spatial positions of the image capturing apparatuses and the information regarding the positional relationship in terms of physical positions between the image capturing apparatuses and the object is represented using coordinate values.

7. The communication apparatus according to claim 1, wherein the acquisition unit acquires image capture information transmitted by the image capturing apparatuses in response to a change in the image capture information.

8. The communication apparatus according to claim 1, wherein the generation unit generates a playlist according to a format defined by MPEG-DASH (Dynamic Adaptive Streaming over Http).

9. A communication apparatus comprising:
a reception unit configured to receive a playlist in which access information associated with a plurality of pieces of video data captured by a plurality of image capturing apparatuses and image capture information associated with the plurality of image capturing apparatuses are described;
a selection unit configured to select at least one of the plurality of pieces of video data based on the image capture information included in the playlist received by the reception unit; and
a transmission unit configured to transmit, to another communication apparatus, a request for transmitting the video data selected by the selection unit based on the access information included in the playlist received by the reception unit.

10. A communication system comprising:
a first communication apparatus comprising:
an acquisition unit configured to acquire image capture information associated with a plurality of image capturing apparatuses;
a generation unit configured to generate a playlist in which access information associated with a plurality of pieces of video data captured by the plurality of image capturing apparatuses and the image capture information acquired by the acquisition unit are described; and
a transmission unit configured to transmit the playlist generated by the generation unit to another communication apparatus; and
a second communication apparatus comprising:
a reception unit configured to receive a playlist in which access information associated with a plurality of pieces of video data captured by a plurality of image capturing apparatuses and image capture information associated with the plurality of image capturing apparatuses are described;
a selection unit configured to select at least one of the plurality of pieces of video data based on the image capture information included in the playlist received by the reception unit; and
a transmission unit configured to transmit, to another communication apparatus, a request for transmitting the video data selected by the selection unit based on the access information included in the playlist received by the reception unit,
wherein the first communication apparatus and the second communication apparatus are connected to each other such that communication to each other is allowed.

11. A communication control method comprising:
acquiring image capture information associated with a plurality of image capturing apparatuses;
generating a playlist in which access information associated with a plurality of pieces of video data captured by the plurality of image capturing apparatuses and the acquired image capture information are described; and
transmitting the generated playlist to another communication apparatus.

12. A communication control method comprising:
receiving a playlist in which access information associated with a plurality of pieces of video data captured by a plurality of image capturing apparatuses and image capture information associated with the plurality of image capturing apparatuses are described;
selecting at least one of the plurality of pieces of video data based on the image capture information included in the received playlist; and
transmitting, to another communication apparatus, a request for transmitting the selected video data based on the access information included in the received playlist.

13. A computer-readable storage medium storing a program for causing a computer to execute a method comprising:
acquiring image capture information associated with a plurality of image capturing apparatuses;
generating a playlist in which access information associated with a plurality of pieces of video data captured by the plurality of image capturing apparatuses and the acquired image capture information are described; and
transmitting the generated playlist to another communication apparatus.

14. A computer-readable storage medium storing a program for causing a computer to execute a method comprising:
receiving a playlist in which access information associated with a plurality of pieces of video data captured by a plurality of image capturing apparatuses and image capture information associated with the plurality of image capturing apparatuses are described;
selecting at least one of the plurality of pieces of video data based on the image capture information included in the received playlist; and
transmitting, to another communication apparatus, a request for transmitting the selected video data based on the access information included in the received playlist.
